(19) United States
(12) Patent Application Publication
(10) Pub. No.: US 2011/0265384 A1
(43) Pub. Date: Nov. 3, 2011

(54) Vertical Cable Manager Door

(75) Inventors: Robert L. Fritz, Elwood, IL (US); Rey Bravo, Manhattan, IL (US); Nathan A. Gleghorn, Chicago, IL (US); David P. Newman, Glen Ellyn, IL (US)

(73) Assignee: PANDUIT CORP., Tinley Park, IL (US)

(21) Appl. No.: 13/096,335

(22) Filed: Apr. 28, 2011

Related U.S. Application Data
(60) Provisional application No. 61/329,445, filed on Apr. 29, 2010.

(51) Int. Cl. E06B 3/36; E05B 65/06

(52) U.S. Cl. 49/394; 49/399

(57) ABSTRACT

Certain embodiments of the present invention provide a door for a vertical cable manager. The door includes a panel. Additionally, the door includes a first hinge pin disposed at a first end of the panel. The first hinge pin slides from an extended position to a retracted position. Additionally, the door includes a first hinge pin retention member disposed adjacent the first hinge pin. The first hinge pin retention member is releasably connected to the first hinge pin to secure the first hinge pin in the retracted position.

### CROSS REFERENCE TO RELATED APPLICATIONS

This application claims the benefit of U.S. Provisional Application No. 61/329,445, filed on Apr. 29, 2010, which is incorporated by reference in its entirety.

### BACKGROUND OF THE INVENTION

The present invention relates to a door for a vertical cable manager. More particularly, the present invention relates to a door for a vertical cable manager, the door spanning the entire height of the vertical cable manager and having an improved automatic retention and release mechanism to ensure proper alignment of the door with the vertical cable manager prior to actuation.

Vertical cable managers having dual-hinging doors are well known in the art. For example, U.S. Patent Application Publication No. 2009/0236117, filed on Jan. 7, 2009 and assigned to Chatsworth Products, Inc. (Westlake Village, Calif.), discloses a vertical cable manager having a dual-hinging door. However, the dual-hinging door does not include an automatic retention and release mechanism.

Dual-hinging doors having automatic retention and release mechanisms are also well known in the art. For example, U.S. Pat. No. 7,385,141, filed on Jan. 30, 2007 and assigned to CommScope, Inc. (Hickory, N.C.), discloses a dual-hinging door having an automatic retention and release mechanism. However, the automatic retention and release mechanism is located at the center of the dual-hinging door. Typically, vertical cable mangers have a height of about 84.0 inches, so the automatic retention and release mechanism is positioned about 42.0 inches from where the dual-hinging door engages the vertical cable manager. Therefore, it is possible to actuate the automatic retention and release mechanism when the dual-hinging door is not properly aligned with the communications rack, potentially damaging both the door and the vertical cable manager and providing access in an otherwise secure environment. It appears that CommScope, Inc. was aware of this problem and attempted to solve it by providing multiple dual-hinging doors to span the height of the vertical cable manager, as shown in FIG. 7 of the '141 patent.

Therefore, there is a need for a door for a vertical cable manager, the door spanning the entire height of the vertical cable manager and having an improved automatic retention and release mechanism to ensure proper alignment of the door with the vertical cable manager prior to actuation.

### SUMMARY OF THE INVENTION

Certain embodiments of the present invention provide a door for a vertical cable manager. The door includes a panel. Additionally, the door includes a first hinge pin disposed at a first end of the panel. The first hinge pin slides from an extended position to a retracted position. Additionally, the door includes a first hinge pin retention member disposed adjacent the first hinge pin. The first hinge pin retention member is releasably connected to the first hinge pin to secure the first hinge pin in the retracted position.

### BRIEF DESCRIPTION OF THE DRAWINGS

FIG. 1 is a front view of a door for a vertical cable manager according to an embodiment of the present invention.

FIG. 2 is a detail view of the door of FIG. 1, showing the knobs.

FIG. 3 is a back view of the door of FIG. 1.

FIG. 4 is a back view of the door of FIG. 1, showing the panel removed.

FIG. 5 is a detail view of the door of FIG. 4, showing the knob arm.

FIG. 6 is a detail view of the door of FIG. 4, showing the hinge pin.

FIG. 7 is a back perspective view of the door of FIG. 1.

FIG. 8 is a detail view of the door of FIG. 7, showing the upper hinge pin assembly.

FIG. 9 is a partially exploded view of the upper hinge pin assembly of FIG. 8.

FIG. 10 is a back perspective view of the upper hinge pin assembly of FIG. 9.

FIG. 11 is a front perspective view of the upper hinge pin assembly of FIG. 9.

FIG. 12 is a partially exploded view of the upper hinge pin assembly of FIG. 11.

FIG. 13 is a perspective view of an upper door bracket for a vertical cable manager according to an embodiment of the present invention.

FIG. 14 is a perspective view of a lower door bracket for a vertical cable manager according to an embodiment of the present invention.

FIG. 15 is a detail view of the door of FIG. 7, showing the top portion of the door connected to the upper door bracket of FIG. 13 and in the open position.

FIG. 16 is a cross-section taken along line 16-16 of FIG. 15, showing the door bracket removed.

FIG. 17 is a detail view of the door of FIG. 7, showing the top portion of the door connected to the upper door bracket of FIG. 13 and in the closed position.

FIG. 18 is a cross-section taken along line 18-18 of FIG. 17, showing the door bracket removed.

FIG. 19 is a detail view of the door of FIG. 7, showing the lower hinge pin assembly.

FIG. 20 is a detail view of the door of FIG. 7, showing the bottom portion of the door connected to the lower door bracket of FIG. 14 and in the open position.

### DETAILED DESCRIPTION OF THE INVENTION

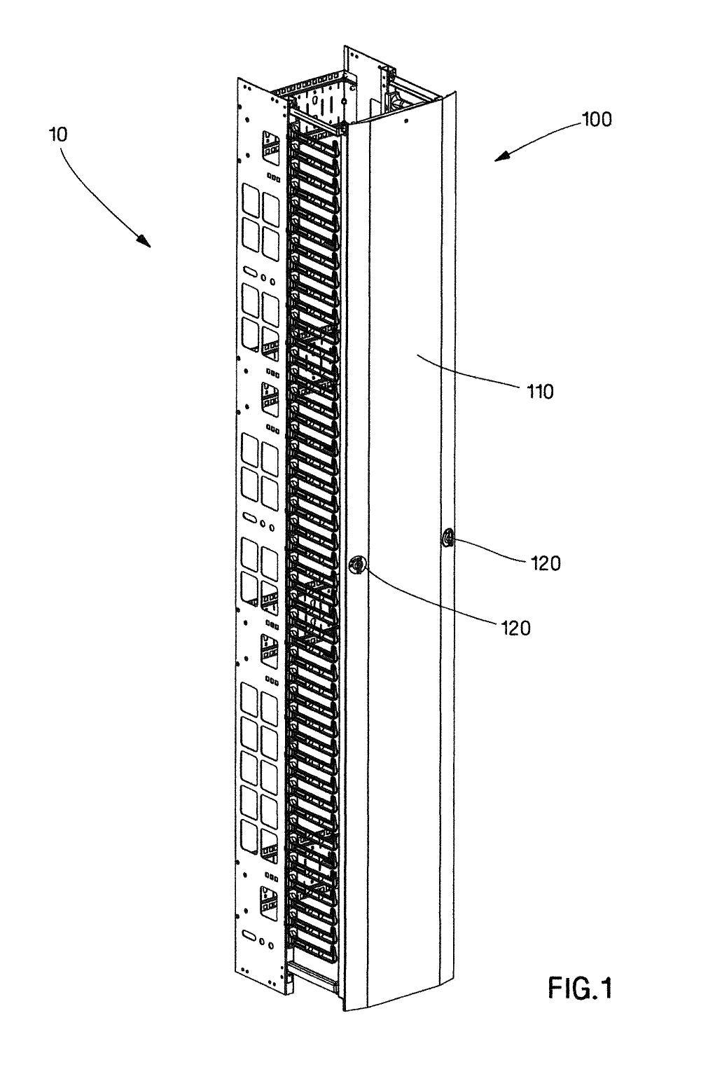

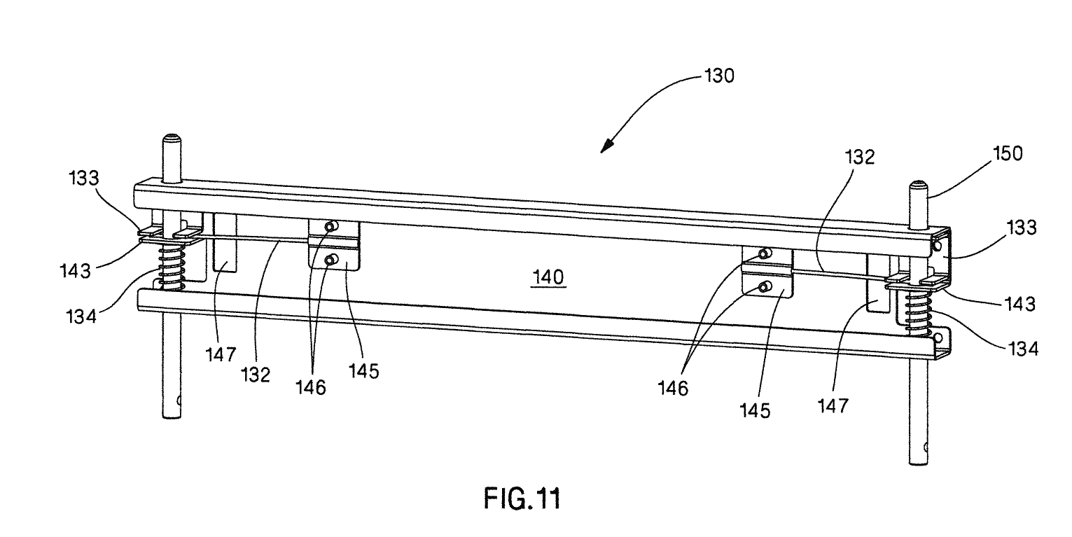

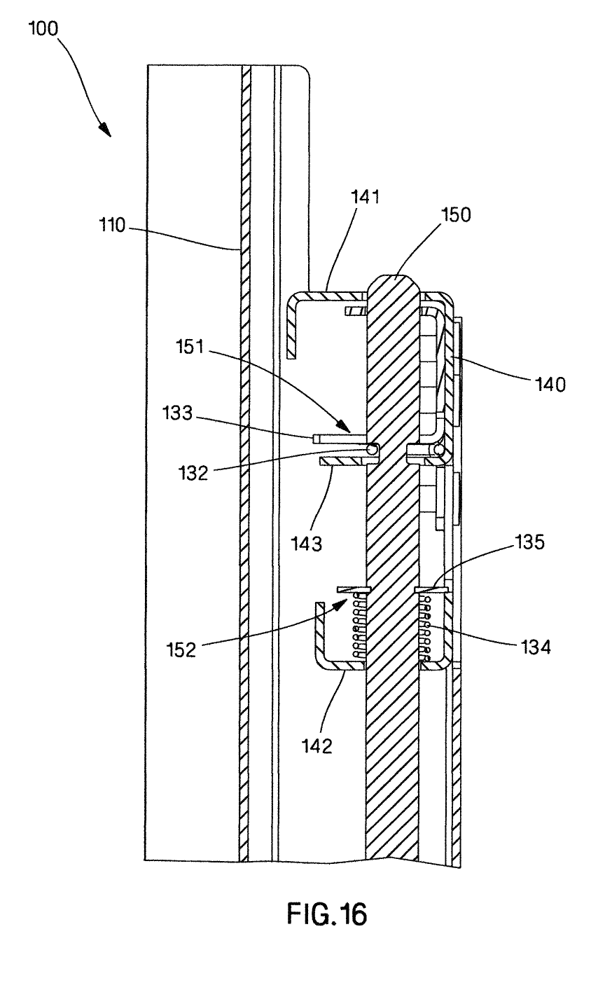

FIGS. 1-20 illustrate a door 100 for a vertical cable manager according to an embodiment of the present invention.

As shown in FIG. 1, the door 100 includes a panel 110 and a pair of knobs 120 rotatably connected to the panel 110. One of the knobs 120 is positioned on the right side of the panel 110 and one of the knobs 120 is positioned on the left side of the panel 110.

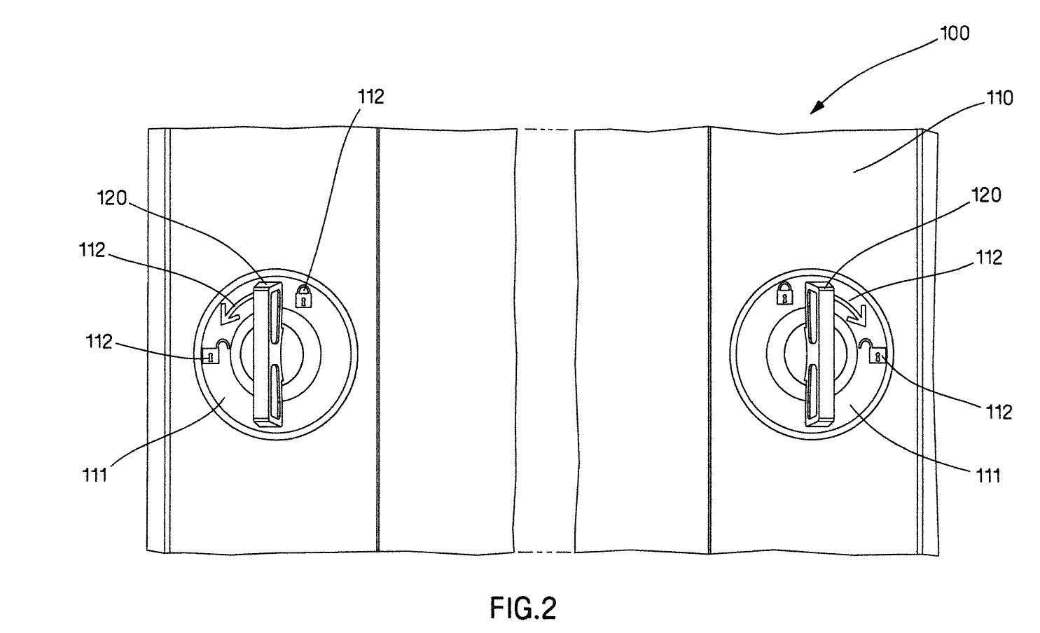

As shown in FIG. 2, the panel 110 includes an indicator area 111 and a plurality of indicators 112 positioned in the indicator area 111 for providing information about the door 100. For example, the door 100 is locked (e.g., the hinge pins are extended) when the knob 120 is pointed toward the locked symbol 112 and the door 100 is unlocked (e.g., the hinge pins are retracted) when the knob 120 is pointed toward the unlocked symbol 112. The arrow symbol 112 indicates a direction of rotation for the knob 120.

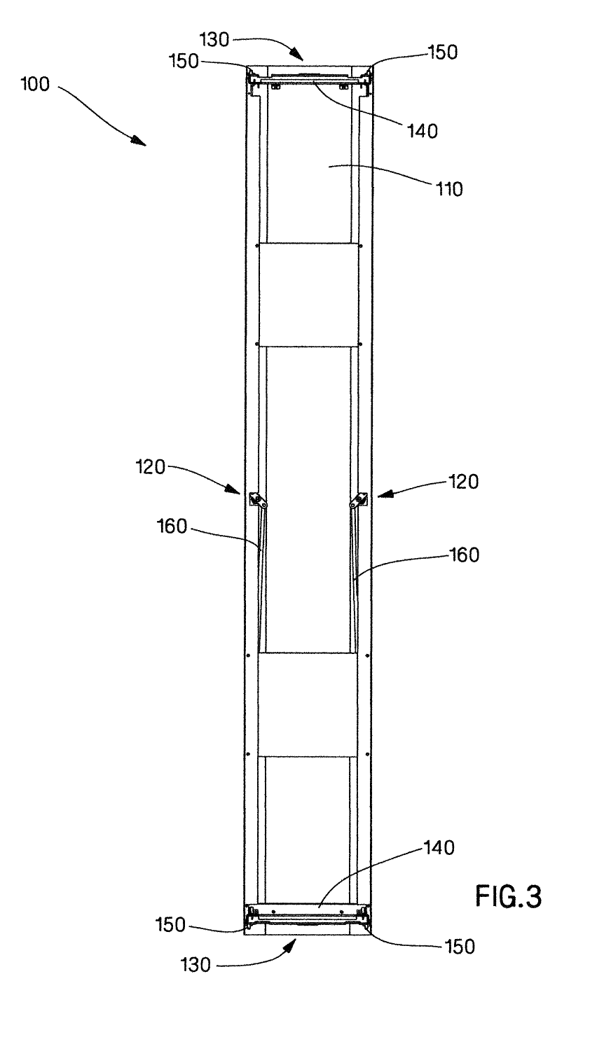

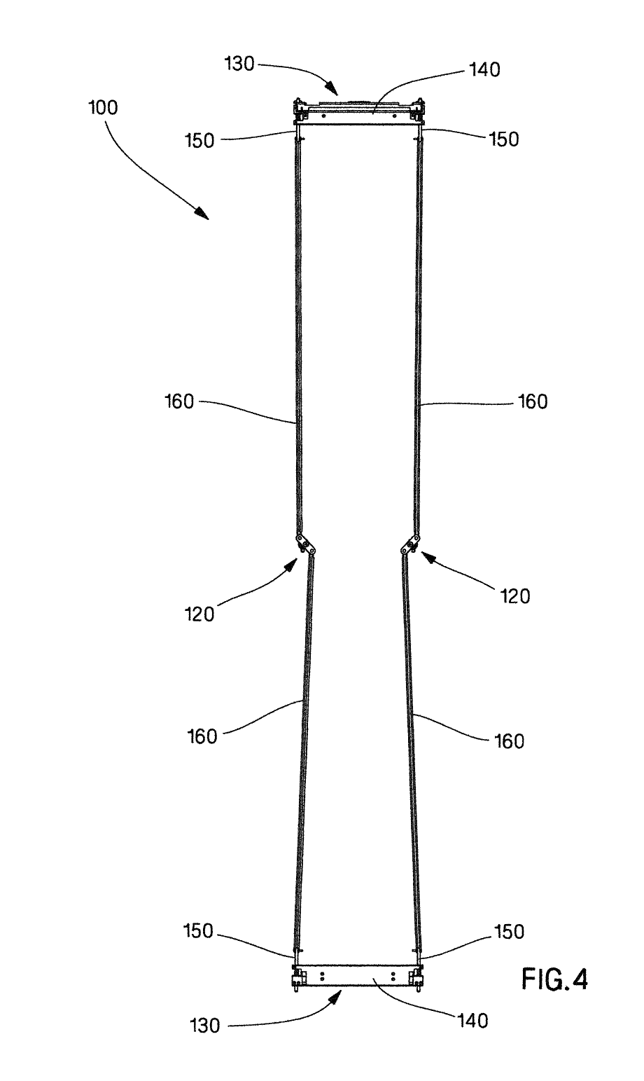

As shown in FIGS. 3 and 4, the door 100 includes a pair of hinge pin assemblies 130 connected to the panel 110. One of the hinge pin assemblies 130 is positioned at the top of the panel 110 and one of the hinge pin assemblies 130 is positioned at the bottom of the panel 110.

The hinge pin assemblies 130 include a housing 140 and a pair of hinge pins 150 slidably connected to the housing 140. One of the hinge pins 150 is positioned on the right side of the housing 140 and one of the hinge pins 150 is positioned on the left side of the housing 140.

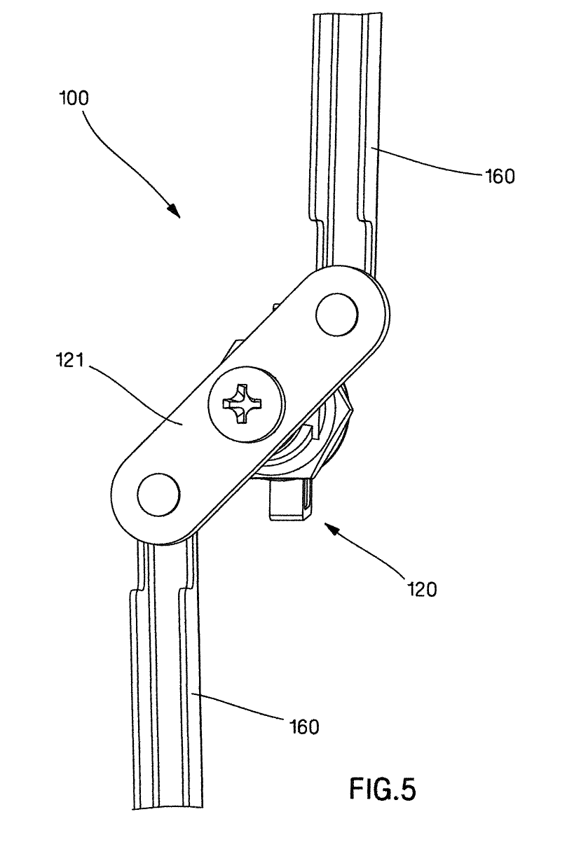

As shown in FIG. 5, the knobs 120 extend through the panel 110 and include a knob arm 121 pivotally connected to a pair of hinge pin arms 160.

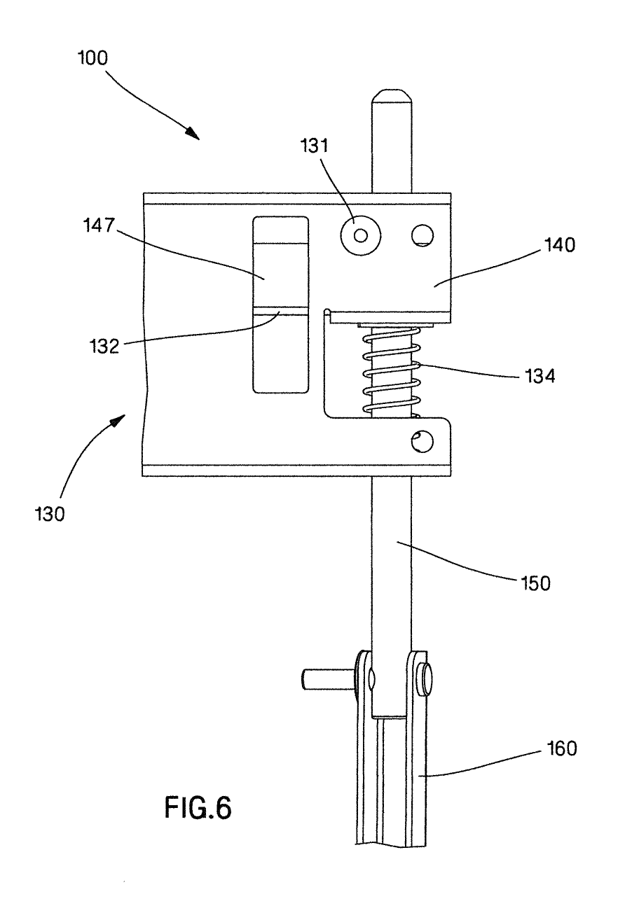

As shown in FIG. 6, the hinge pin arms 160 are pivotally connected to the hinge pins 150.

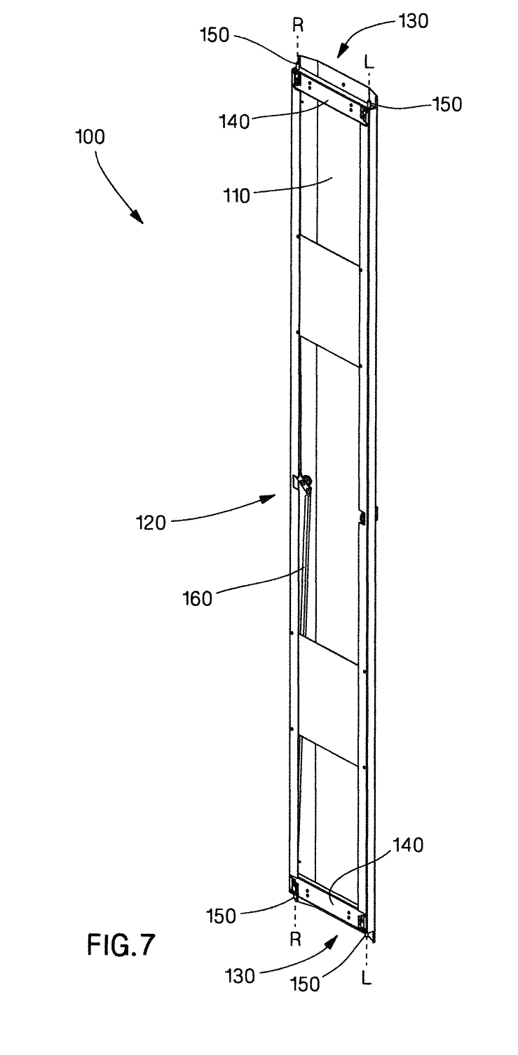

As shown in FIG. 7, the hinge pins 150 positioned on the right side of the door 100 (the left side of FIG. 7) define an axis of rotation R. Similarly, the hinge pins 150 positioned on the left side of the door 100 (the right side of FIG. 7) define an axis of rotation L. Such a configuration allows the door 100 to be opened from the right side or the left side, or removed from the vertical cable manager.

To open the door 100 from the right side, the knob 120 on the right side of the door 100 is rotated clockwise, which retracts the hinge pins 150 on the right side of the door 100 and allows the door 100 to rotate about the hinge pins 150 on the left side of the door 100 or the axis of rotation L.

To open the door 100 from the left side, the knob 120 on the left side of the door 100 is rotated counterclockwise, which retracts the hinge pins 150 of the left side of the door 100 and allows the door 100 to rotate about the hinge pins 150 on the right side of the door 100 or the axis of rotation R.

To remove the door 100 from the vertical cable manager, the knob 120 on the right side of the door 100 is rotated clockwise and the knob 120 on the left side of the door 100 is rotated counterclockwise, which retracts all of the hinge pins 150 and allows the door 100 to be removed from the vertical cable manager.

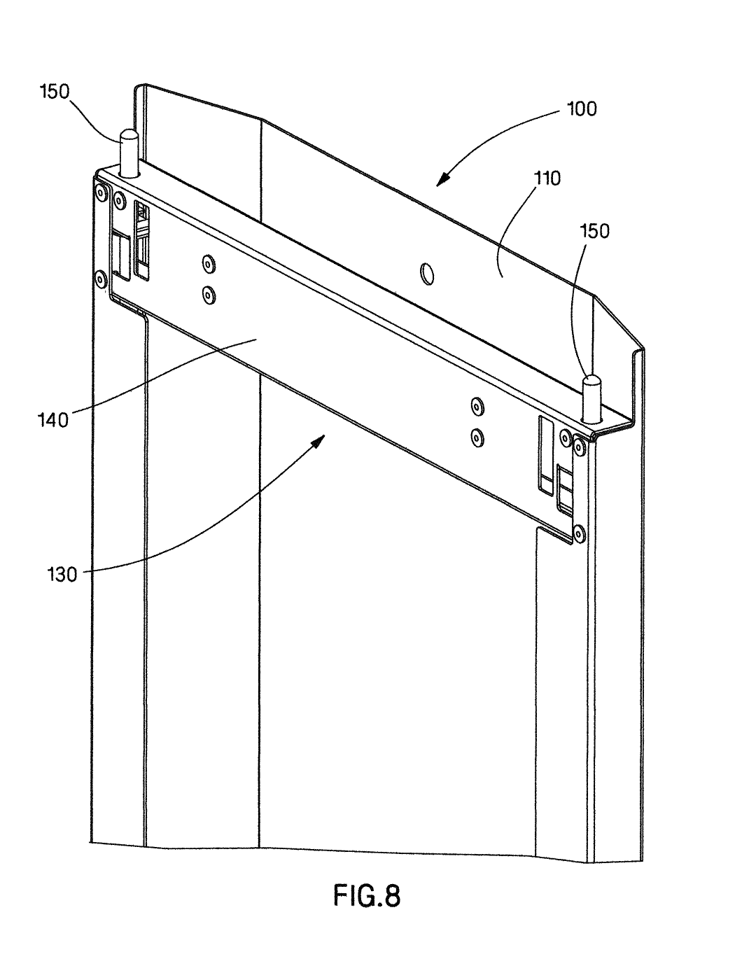

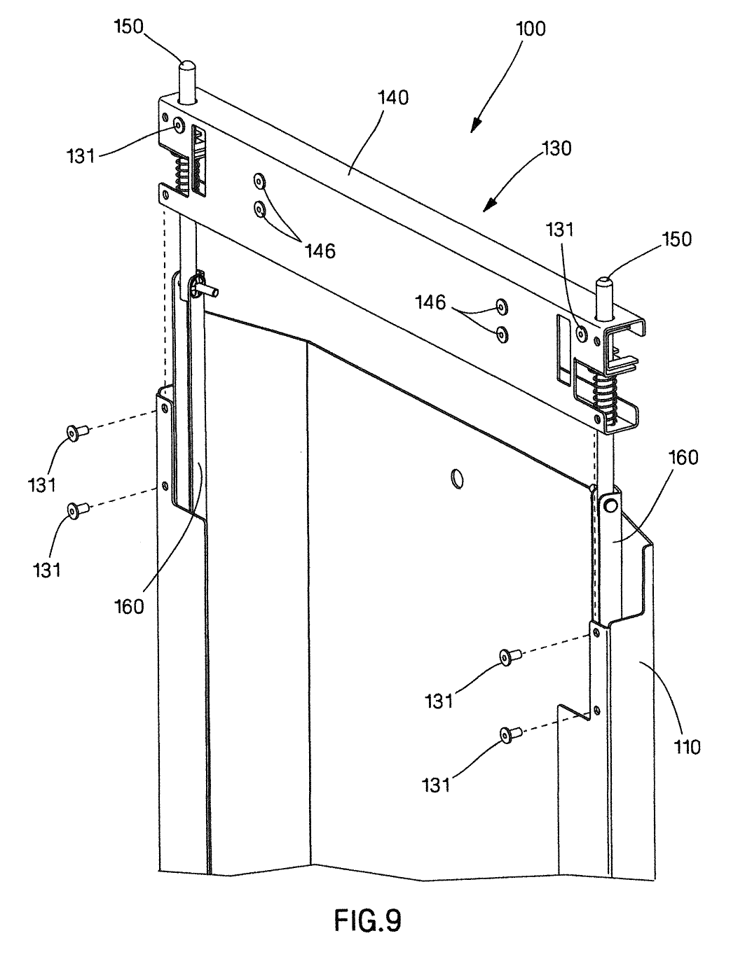

As shown in FIGS. 8 and 9, the hinge pin assemblies 130 are connected to the panel 110 of the door 100, for example, using a plurality of fasteners 131, such as rivets.

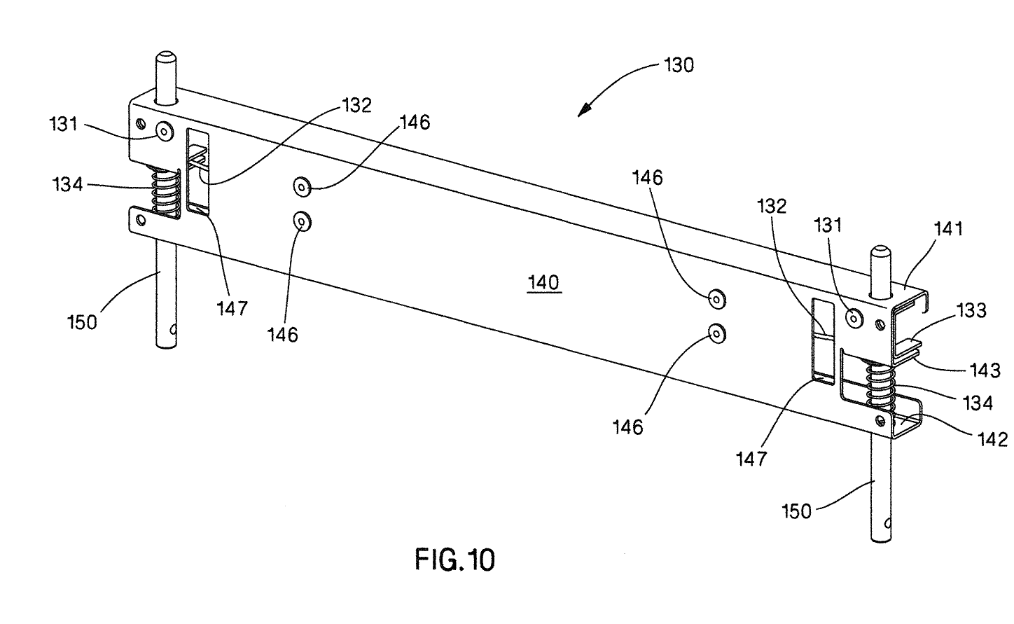

As shown in FIGS. 10-12, in addition to the housing 140 and the hinge pins 150, the hinge pin assemblies 130 include a pair of hinge pin retainers 132, a pair of hinge pin retainer flanges 133, a pair of springs 134, and a pair of spring retainers 135.

Additionally, the hinge pin assemblies 130 include a pair of hinge pin retainer clamps 145 and corresponding fasteners, such as rivets, for connecting the hinge pin retainers 132 to the housing 140.

The housing 140 includes a first flange 141, a second flange 142, and a pair of third flanges 143. The flanges 141-143 include a plurality of openings 144 for receiving and supporting the hinge pins 150.

Additionally, the housing 140 includes a pair of openings 147 for accessing the hinge pin retainer 132.

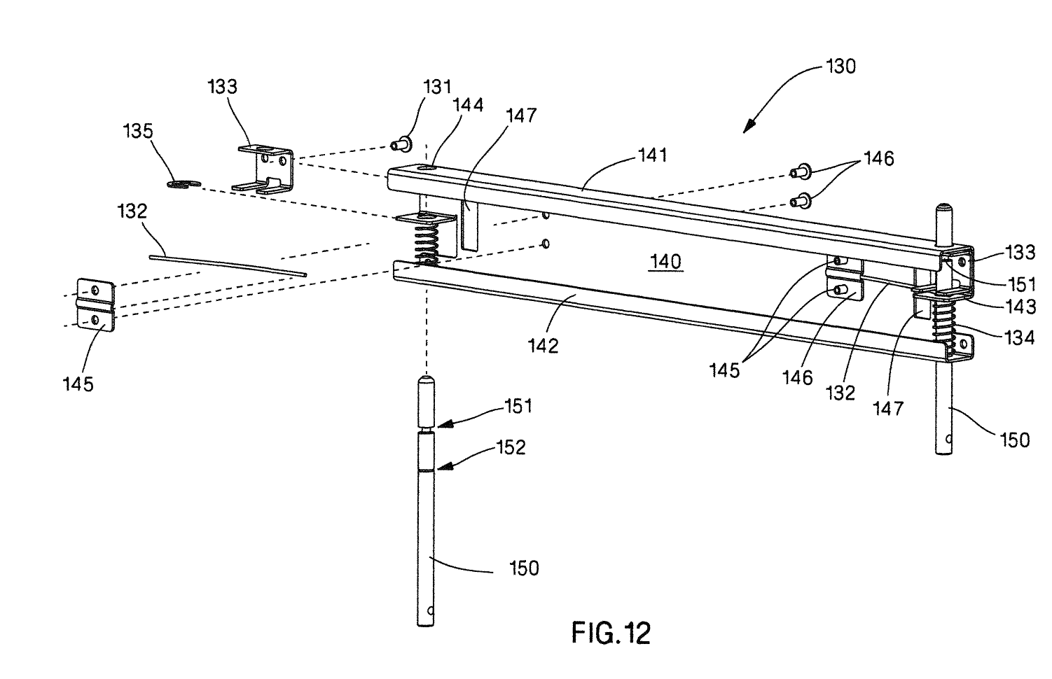

As shown in FIG. 12, the hinge pins 150 include a first annular groove 151 for receiving the hinge pin retainer 132 and a second annular groove 152 for receiving the spring retainer 135.

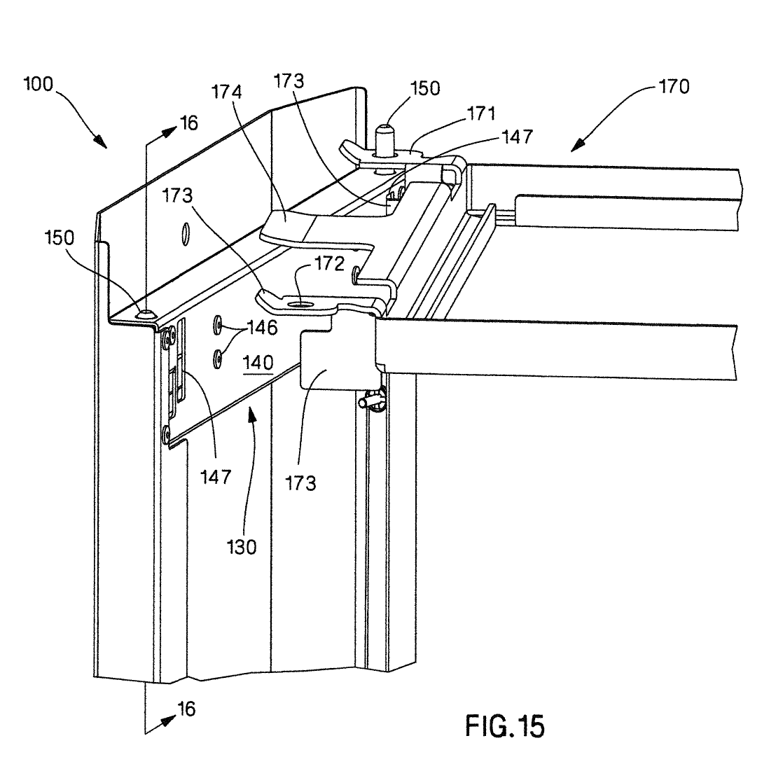

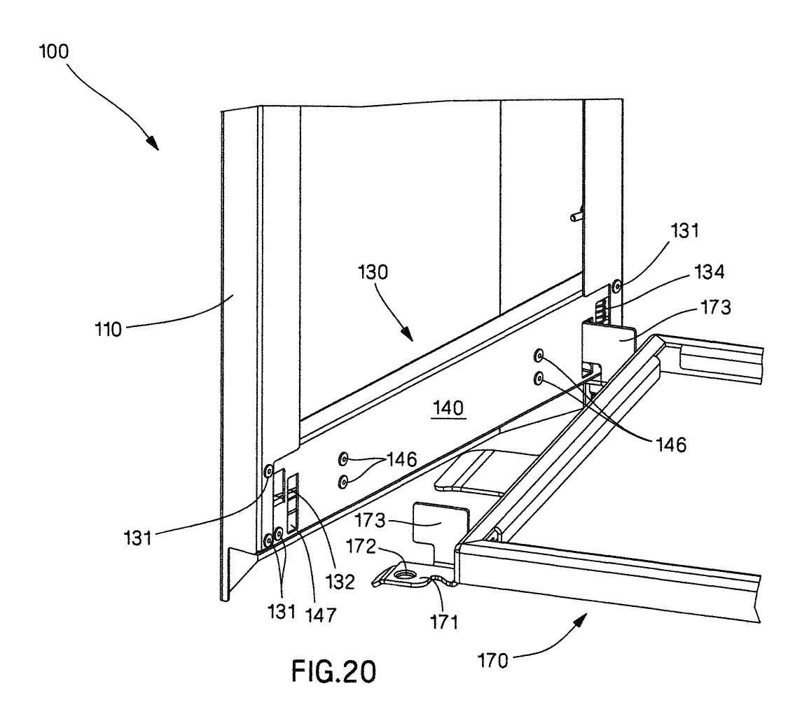

The hinge pin retainer 132, such as a retaining rod, is positioned between the hinge pin retainer flanges 133 and the third flanges 143 of the housing 140. The hinge pin retainer flanges 133 are connected to the housing 140, for example, using the fasteners 131. The hinge pin retainers 132 secure the hinge pins 150 in a retracted position (FIGS. 15 and 20).

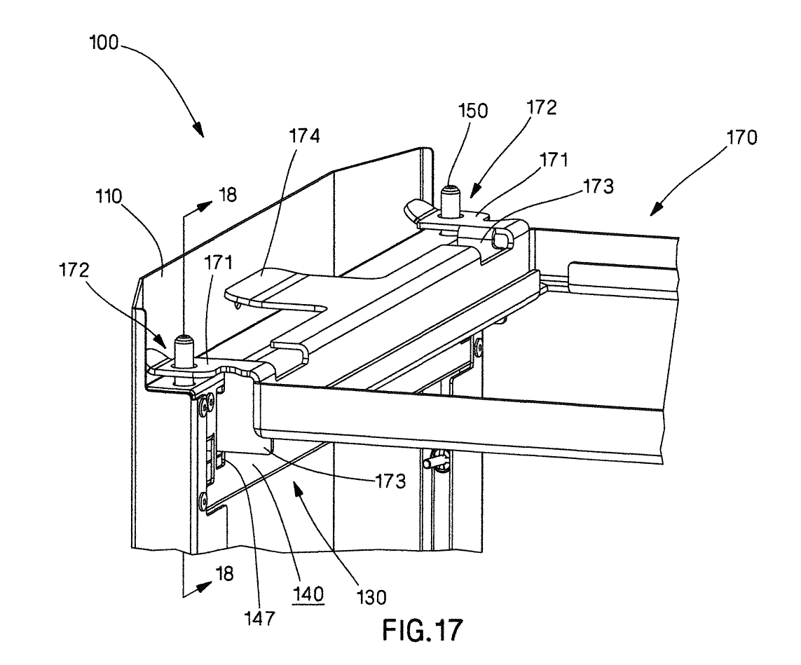

The springs 134 are positioned between the second flange 142 and the third flanges 143 and connected to the hinge pins 150, for example, using the spring retainers 133, such as retaining rings or e-rings. The springs 134 bias the hinge pins 150 in an extended position (FIG. 17).

The vertical cable manager includes a pair of door brackets 170. One door bracket 170 is positioned at the top of the vertical cable manager (FIGS. 15 and 17) and one door bracket 170 is positioned at the bottom of the vertical cable manager (FIG. 20).

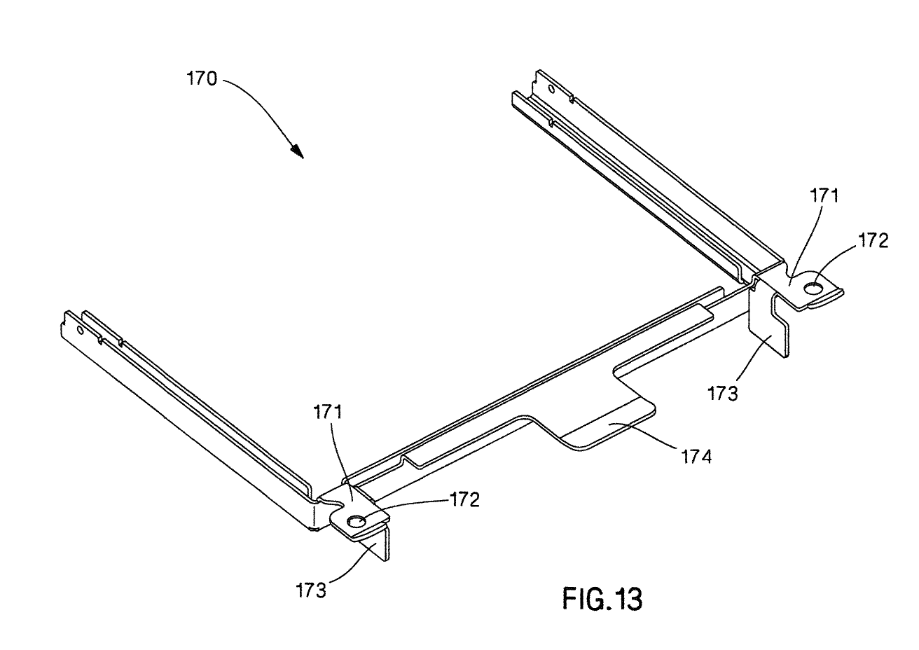

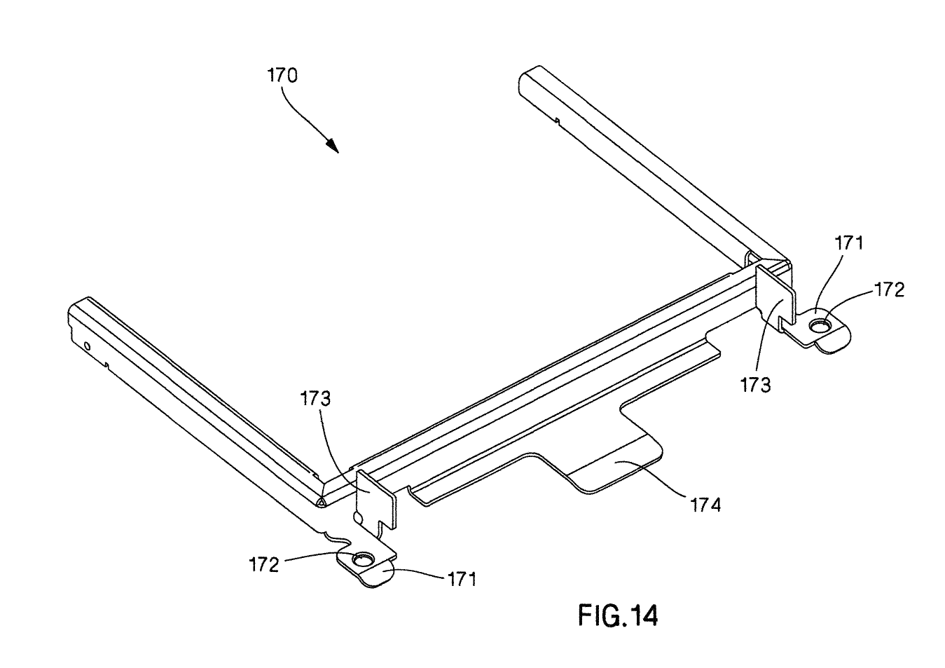

As shown in FIGS. 13 and 14, the door brackets 170 include a pair of guide tabs 171 and a pair of hinge pins holes 172 positioned on the guide tabs 171 for receiving the hinge pins 150.

Additionally, the door brackets 170 include a pair of release tabs 173 for engaging the hinge pin retainers 132 through the openings 147 in the housing 140 when the door 100 is closed. The release tabs 173 are positioned adjacent the guide tabs 171 and the hinge pin holes 172.

Additionally, the door brackets 170 include an alignment tab 174 for aligning the door 100 with the door brackets 170. For example, as shown in FIG. 20, the alignment tab 174 on the lower door bracket 170 engages the housing 140 of the lower hinge pin assembly 130, lifting the door 100 into proper alignment with the lower door bracket 170. The alignment tab 174 is positioned between the hinge pin holes 172 and extends beyond the guide tabs 171. Preferably, the alignment tab 174 is equidistantly spaced between the hinge pin holes 172 to accommodate the dual-hinging door 100.

Additional examples of door brackets and other door mounting configurations for vertical cable managers are provided in U.S. patent application Ser. No. 11/086,815, filed on Mar. 22, 2005, and U.S. patent application Ser. No. 11/123,369, filed on May 6, 2005, both of which are assigned to Panduit Corp. (Tinley Park, Ill.) and incorporated by reference in their entirety.

As shown in FIGS. 15, 17, and 20, the door 100 is rotatably connected to the door brackets 170 of the vertical cable manager and rotates from an open position (FIGS. 15 and 20) to a closed position (FIG. 17). The door 100 is open on the right side and rotates about the hinge pins 150 on the left side or axis of rotation L (FIG. 7), but it is likewise contemplated that the door 100 opens on the left side and rotates about the hinge pins 150 on the right side or axis of rotation R (FIG. 7).

As shown in FIGS. 15, 16, and 20, when the door 100 is opened, the upper and lower hinge pins 150 on the right side of the door 100 are in the retracted position. The hinge pin retainers 132 engage the annular grooves 151 on the hinge pins 150, securing the hinge pins 150 in the retracted position.

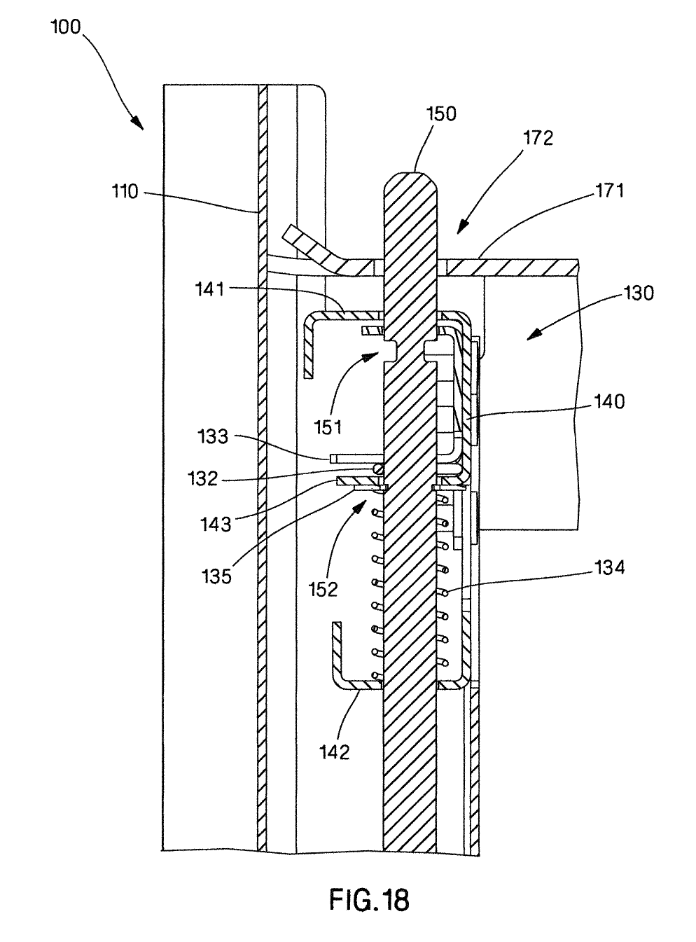

As shown in FIGS. 17 and 18, when the door 100 is closed, the hinge pins 150 on the right side of the door 100 are in the extended position. The release tabs 173 on the door brackets 170 extend through the openings 147 in the housing 140 and engage the hinge pin retainers 132, causing the hinge pin retainers 132 to disengage from the annular grooves 151 on the hinge pins 150 and allowing the springs 134 to return the hinge pins 150 to the extended position.

However, if only one of the hinge pin retainers 132 is disengaged from the annular groove 151 in the hinge pin 150, indicating that the door 100 is not properly aligned with the door brackets 170, the other hinge pin retainer 132 will secure both of the hinge pins 150 in the retraced position because the hinge pins 150 are connected to the knob 120 via the knob arm 121 and the hinge pin arms 160.

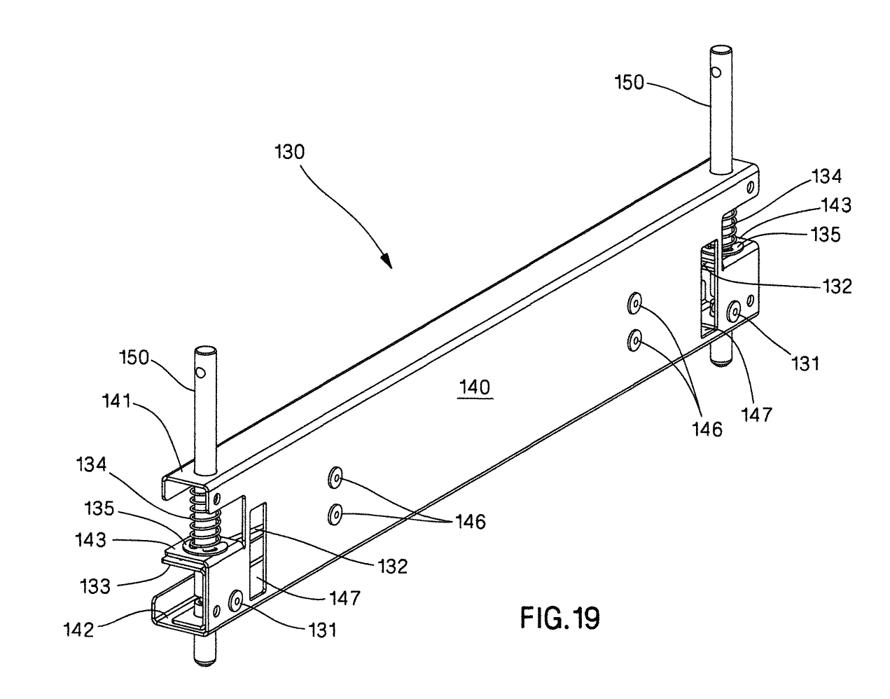

As shown in FIGS. 19 and 20, the housing 140 of the lower hinge pin assembly 130 includes an alignment insert 148, such as a smooth stainless steel insert, for engaging the alignment tab 174 on the lower door bracket 170 and reducing friction between the door 100 and the door bracket 170, making the door 100 easier to open and close.

It should be understood, of course, that the foregoing relates to exemplary embodiments of the disclosure and modifications may be made without departing from the spirit and scope of the disclosure.

1. A door for a vertical cable manager, the door comprising:
a panel;
a first hinge pin disposed at a first end of the panel, wherein the first hinge pin slides from an extended position to a retracted position;
a first hinge pin retention member disposed adjacent the first hinge pin, wherein the first hinge pin retention member is releasably connected to the first hinge pin to secure the first hinge pin in the retracted position.

2. The door of claim 1, wherein the vertical cable manager has a height and the panel spans the height of the vertical cable manager.

3. The door of claim 1, wherein the door is rotatably and removably connected to the vertical cable manager.

4. The door of claim 1, wherein the first hinge pin engages the vertical cable manager in the extended position.

5. The door of claim 1, wherein the first hinge pin disengages the vertical cable manager in the retracted position.

6. The door of claim 1, wherein the first hinge pin includes an annular groove for receiving the first hinge pin retention member.

7. The door of claim 1, wherein the first hinge pin retention member includes a flexible rod.

8. The door of claim 1, further comprising a latch operably connected to the first hinge pin such that operation of the latch causes the first hinge pin to slide from the extended position to the retracted position, engaging the first hinge pin retention member.

9. The door of claim 8, further comprising a latch arm connected to the latch and a first hinge pin arm rotatably connected to the latch arm and the first hinge pin.

10. The door of claim 1, further comprising a spring operably connected to the first hinge pin to bias the first hinge pin in the extended position.

11. The door of claim 10, wherein, when the door is rotated from an open position to a closed position, the vertical cable manager releases the first hinge pin retention member, causing the first hinge pin to slide from the retracted position to the extended position.

12. The door of claim 10, wherein the first hinge pin includes an annular groove for receiving the spring.

13. The door of claim 1, further comprising a second hinge pin disposed at a second end of the panel, the second end opposite the first end of the panel.

14. The door of claim 13, wherein the first hinge pin and the second hinge pin define an axis of rotation for the door.

15. The door of claim 14, further comprising a third hinge pin disposed at the first end of the panel and spaced apart from the first hinge pin and a fourth hinge pin disposed at the second end of the panel and spaced apart from the second hinge pin, wherein the third hinge pin and the fourth hinge pin define a second axis of rotation for the door.

16. The door of claim 13, further comprising a second hinge pin retention member disposed adjacent the second hinge pin.

17. The door of claim 16, wherein the second hinge pin retention member is releasably connected to the second hinge pin to secure the second hinge pin in the retracted position.

18. The door of claim 17, wherein the second hinge pin is operably connected to the first hinge pin such that the first hinge pin retention member secures the first hinge pin and the second hinge pin in the retracted position when the second hinge pin retainer is released.

19. The door of claim 17, further comprising a latch operably connected to the first hinge pin and the second hinge pin such that operation of the latch causes the first hinge pin to slide from the extended position to the retracted position, engaging the first hinge pin retention member, and the second hinge pin to slide from the extended position to the retracted position, engaging the second hinge pin retention member.

20. The door of claim 19, further comprising a latch arm connected to the latch, a first hinge pin arm rotatably connected to the latch arm and the first hinge pin, and a second hinge pin arm rotatably connected to the latch arm and the second hinge pin.
